(19) United States
(12) Patent Application Publication
(10) Pub. No.: US 2022/0321495 A1
(43) Pub. Date: Oct. 6, 2022

(54) EFFICIENT TROUBLE SHOOTING ON CONTAINER NETWORK BY CORRELATING KUBERNETES RESOURCES AND UNDERLYING RESOURCES

(71) Applicant: VMware, Inc., Palo Alto, CA (US)

(72) Inventors: Wenfeng Liu, Beijing (CN); Jianjun Shen, Redwood City, CA (US); Ran Gu, Beijing (CN); Rui Cao, Beijing (CN); Donghai Han, Beijing (CN)

(21) Appl. No.: 17/333,136

(22) Filed: May 28, 2021

(30) Foreign Application Priority Data
Mar. 30, 2021 (CN) PCTCN2021083961

(51) Int. Cl. H04L 12/911; H04L 12/917; H04L 12/24

(52) U.S. Cl. CPC H04L 47/746; H04L 47/76; H04L 47/781; H04L 41/22; H04L 41/0627

(57) ABSTRACT

Some embodiments provide a method of tracking errors in a container cluster network overlaying a software defined network (SDN), sometimes referred to as a virtual network. The method sends a request to instantiate a container cluster network object to an SDN manager of the SDN. The method then receives an identifier of a network resource of the SDN for instantiating the container cluster network object. The method associates the identified network resource with the container cluster network object. The method then receives an error message regarding the network resource from the SDN manager. The method identifies the error message as applying to the container cluster network object. The error message, in some embodiments, indicates a failure to initialize the network resource. The container cluster network object may be a namespace, a pod of containers, or a service.

In recent years, computer networks have continued to evolve for more efficient usage of resources. As companies have needed to scale up the deployment of programs for use over the internet and other networks, older practices of running a single copy of a program on each of a number of physical computers have been largely replaced with multiple virtual machines running on each of several host computers. Implementing multiple virtual machines allowed for more granularity in deploying different programs. Additionally, by simulating a full, general purpose computer, systems of virtual machines maintained operability of the large existing base of programs designed to run on general purpose computers.

Although deploying a virtual machine may be faster than booting an entire physical host computer, it is still relatively slow compared to deploying containers of a containerized system such as Kubernetes (sometimes called k8s or kubes). Such containers do not need a separate operating system like a virtual machine. Therefore, Kubernetes deployments are becoming increasingly popular alternatives to virtual machines. However, in the prior art, Kubernetes systems do not have an efficient way of tracking errors that affect Kubernetes resources to the underlying resources that are the source of those errors in the virtual networks that implement the Kubernetes resources.

### BRIEF SUMMARY

Some embodiments provide a method of tracking errors in a container cluster network overlaying a software defined network (SDN), sometimes referred to as a virtual network. The method sends a request to instantiate a container cluster network object to an SDN manager of the SDN. The method then receives an identifier of a network resource of the SDN for instantiating the container cluster network object. The method associates the identified network resource with the container cluster network object. The method then receives an error message regarding the network resource from the SDN manager. The method identifies the error message as applying to the container cluster network object. The error message, in some embodiments, indicates a failure to initialize the network resource. The container cluster network object may be a namespace, a pod of containers, or a service.

The method of some embodiments associates the identified network resource with the container cluster network object by creating a tag for the identified network resource that identifies the container cluster network object. The tag may include a universally unique identifier (UUID). Associating the identified network resource with the container cluster network object may include creating an inventory of network resources used to instantiate the container cluster network object and adding the identifier of the network resource to the inventory. The network resource, in some embodiments, is one of multiple network resources for instantiating the container cluster network object. In such embodiments, the method also receives an identifier of a second network resource of the SDN for instantiating the container cluster network object and adds the identifier of the second network resource to the inventory.

The method of some embodiments also displays, in a graphical user interface (GUI), an identifier of the inventory of the network resources in association with an identifier of the container cluster network object. The method may also display the error message in association with the inventory of network resources. Displaying the inventory may further include displaying a status of the instantiation of the container cluster network object.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates an example of a control system of some embodiments of the invention.

FIG. 2 illustrates a system 200 for correlating Kubernetes resources with underlying SDN resources.

FIG. 3 conceptually illustrates a process for correlating Kubernetes resources with underlying resources of an SDN.

FIG. 4 illustrates a system that correlates a Kubernetes pod object with a port (a segment port for the pod).

FIG. 5 illustrates a Kubernetes inventory UI of some embodiments.

FIG. 6 illustrates a system that correlates a Kubernetes Namespace object with an IP Pool.

FIG. 7 illustrates a system that correlates a Kubernetes virtual server object with an IP address.

FIG. 8 illustrates a data structure for tracking correlations of Kubernetes resources to resources of an underlying SDN used to implement the Kubernetes resources.

FIG. 9 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a method of tracking errors in a container cluster network overlaying an SDN. The method sends a request to instantiate a container cluster network object to an SDN manager of the SDN. The method then receives an identifier of a network resource of the SDN for instantiating the container cluster network object. The method associates the identified network resource with the container cluster network object. The method then receives an error message regarding the network resource from the SDN manager. The method identifies the error message as applying to the container cluster network object. The error message, in some embodiments, indicates a failure to initialize the network resource. The container cluster network object may be a namespace, a pod of containers, or a service.

The method of some embodiments associates the identified network resource with the container cluster network object by creating a tag for the identified network resource that identifies the container cluster network object. The tag may include a universally unique identifier (UUID). Associating the identified network resource with the container cluster network object may include creating an inventory of network resources used to instantiate the container cluster network object and adding the identifier of the network resource to the inventory. The network resource, in some embodiments, is one of multiple network resources for instantiating the container cluster network object. In such embodiments, the method also receives an identifier of a second network resource of the SDN for instantiating the container cluster network object and adds the identifier of the second network resource to the inventory.

The method of some embodiments also displays, in a graphical user interface (GUI), an identifier of the inventory of the network resources in association with an identifier of the container cluster network object. The method may also display the error message in association with the inventory of network resources. Displaying the inventory may further include displaying a status of the instantiation of the container cluster network object.

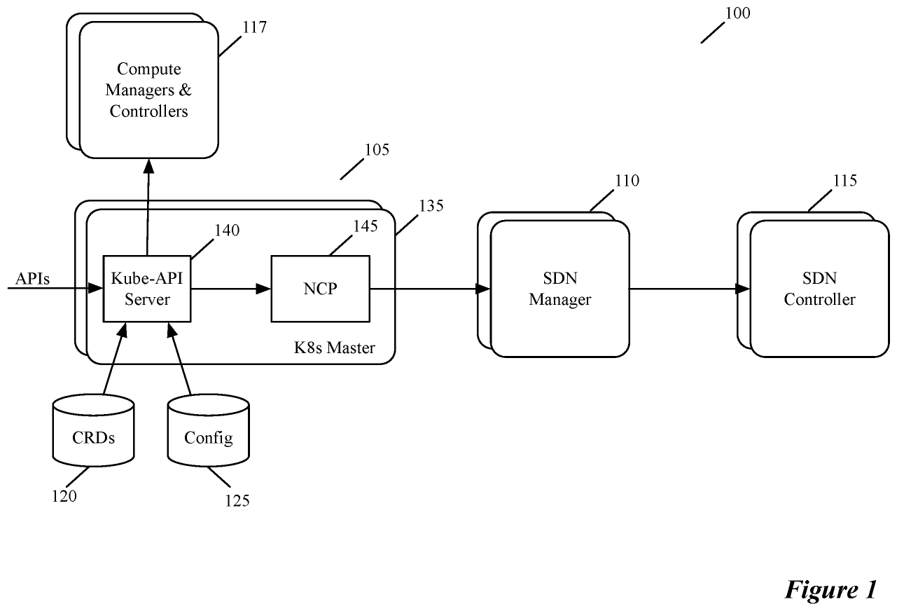

The present invention is implemented in systems of container clusters operating on an underlying network such as a Kubernetes system. FIG. 1 illustrates an example of a control system 100 of some embodiments of the invention. This system 100 processes Application Programming Interfaces (APIs) that use the Kubernetes-based declarative model to describe the desired state of (1) the machines to deploy, and (2) the connectivity, security and service operations that are to be performed for the deployed machines (e.g., private and public IP addresses connectivity, load balancing, security policies, etc.). An application programming interface is a computing interface that defines interactions between different software and/or hardware systems.

To deploy the network elements, the method of some embodiments uses one or more Custom Resource Definitions (CRDs) to define attributes of custom-specified network resources that are referred to by the received API requests. When these API requests are Kubernetes APIs, the CRDs define extensions to the Kubernetes networking requirements. Therefore, to process these APIs, the control system 100 uses one or more CRDs to define some of the resources referenced in the APIs. Further description of the CRDs of some embodiments is found in U.S. patent application Ser. No. 16/897,652, which is incorporated herein by reference.

The system 100 performs automated processes to deploy a logical network that connects the deployed machines and segregates these machines from other machines in the datacenter set. The machines are connected to the deployed logical network of a virtual private cloud (VPC) in some embodiments.

As shown, the control system 100 includes an API processing cluster 105, an SDN manager cluster 110, an SDN controller cluster 115, and compute managers and controllers 117. The API processing cluster 105 includes two or more API processing nodes 135, with each node comprising an API processing server 140 and a network container plugin (NCP) 145. The API processing server 140 receives intent-based API calls and parses these calls. In some embodiments, the received API calls are in a declarative, hierarchical Kubernetes format, and may contain multiple different requests.

The API processing server 140 parses each received intent-based API request into one or more individual requests. When the API requests relate to the deployment of machines, the API server 140 provides these requests directly to the compute managers and controllers 117, or indirectly provides these requests to the compute managers and controllers 117 through an agent running on the Kubernetes master node 135. The compute managers and controllers 117 then deploy virtual machines (VMs) and/or Kubernetes Pods on host computers of a physical network that underlies the SDN.

The API calls can also include requests that require network elements to be deployed. In some embodiments, these requests explicitly identify the network elements to deploy, while in other embodiments the requests can also implicitly identify these network elements by requesting the deployment of compute constructs (e.g., compute clusters, containers, etc.) for which network elements have to be defined by default. The control system 100 uses the NCP 145 to identify the network elements that need to be deployed, and to direct the deployment of these network elements.

In some embodiments, the API calls refer to extended resources that are not defined per se by the standard Kubernetes system. For these references, the API processing server 140 uses one or more CRDs 120 to interpret the references in the API calls to the extended resources. As mentioned above, the CRDs in some embodiments include the virtual interface (VIF), Virtual Network, Endpoint Group, Security Policy, Admin Policy, and Load Balancer and virtual service object (VSO) CRDs. In some embodiments, the CRDs are provided to the API processing server in one stream with the API calls.

The NCP 145 is the interface between the API server 140 and the SDN manager cluster 110 that manages the network elements that serve as the forwarding elements (e.g., switches, routers, bridges, etc.) and service elements (e.g., firewalls, load balancers, etc.) in the SDN and/or a physical network underlying the SDN. The SDN manager cluster 110 directs the SDN controller cluster 115 to configure the network elements to implement the desired forwarding elements and/or service elements (e.g., logical forwarding elements and logical service elements) of one or more logical networks. As further described below, the SDN controller cluster interacts with local controllers on host computers and edge gateways to configure the network elements in some embodiments.

In some embodiments, the NCP 145 registers for event notifications with the API server 140, e.g., sets up a long-pull session with the API server 140 to receive all CRUD (Create, Read, Update and Delete) events for various CRDs that are defined for networking. In some embodiments, the API server 140 is a Kubernetes master VM, and the NCP 145 runs in this VM as a Pod. The NCP 145 in some embodiments collects realization data from the SDN resources for the CRDs and provides this realization data as it relates to the CRD status.

In some embodiments, the NCP 145 processes the parsed API requests relating to VIFs, virtual networks, load balancers, endpoint groups, security policies, and VSOs, to direct the SDN manager cluster 110 to implement (1) the VIFs needed to connect VMs and Pods to forwarding elements on host computers, (2) virtual networks to implement different segments of a logical network of the VPC, (3) load balancers to distribute the traffic load to endpoint machines, (4) firewalls to implement security and admin policies, and (5) exposed ports to access services provided by a set of machines in the VPC to machines outside and inside of the VPC.

The API server 140 provides the CRDs that have been defined for these extended network constructs to the NCP 145 for it to process the APIs that refer to the corresponding network constructs. The API server 140 also provides configuration data from the configuration storage 125 to the NCP 145. The configuration data in some embodiments include parameters that adjust the pre-defined template rules that the NCP 145 follows to perform its automated processes. The NCP 145 performs these automated processes to execute the received API requests in order to direct the SDN manager cluster 110 to deploy the network elements for the VPC. For a received API, the control system 100 performs one or more automated processes to identify and deploy one or more network elements that are used to implement the logical network for a VPC. The control system performs these automated processes without an administrator performing any action to direct the identification and deployment of the network elements after an API request is received.

The SDN managers 110 and controllers 115 can be any SDN managers and controllers available today. In some embodiments, these managers and controllers are the network managers and controllers, like NSX-T managers and controllers licensed by VMware Inc. In such embodiments, the NCP 145 detects network events by processing the data supplied by its corresponding API server 140, and uses NSX-T APIs to direct the network manager 110 to deploy and/or modify NSX-T network constructs needed to implement the network state expressed by the API calls. The communication between the NCP and network manager 110 is asynchronous communication, in which the NCP 145 provides the desired state to the network managers 110, which then relay the desired state to the network controllers 115 to compute and disseminate the state asynchronously to the host computer, forwarding elements and service nodes in the network controlled by the SDN controllers and/or the physical network underlying the SDN.

The SDN controlled by the SDN controllers in some embodiments is a logical network comprising multiple logical constructs (e.g., NSX-T constructs). In such embodiments, the Kubernetes containers and objects are implemented by underlying logical constructs of the SDN, which are in turn implemented by underlying physical hosts, servers, or other mechanisms. For example, a Kubernetes container may use a Kubernetes switch that is implemented by a logical switch of an SDN underlying the Kubernetes network, and the logical switch in turn is implemented by one or more physical switches of a physical network underlying the SDN. In some embodiments, in addition to tracking relationships between the Kubernetes objects and SDN resources that implement and/or support the Kubernetes objects, the methods herein also track the relationships between physical network elements, the SDN elements they implement or support, and the Kubernetes objects those SDN elements implement and support. That is, in some embodiments, the relationship tracking includes an extra layer, enabling a user to discover not only the source (in the SDN) of errors in the Kubernetes network that originate in the SDN, but also the source (in the physical network) of errors in the Kubernetes network that originate in the physical network.

After receiving the APIs from the NCPs 145, the SDN managers 110 in some embodiments direct the SDN controllers 115 to configure the network elements to implement the network state expressed by the API calls. In some embodiments, the SDN controllers serve as the central control plane (CCP) of the control system 100.

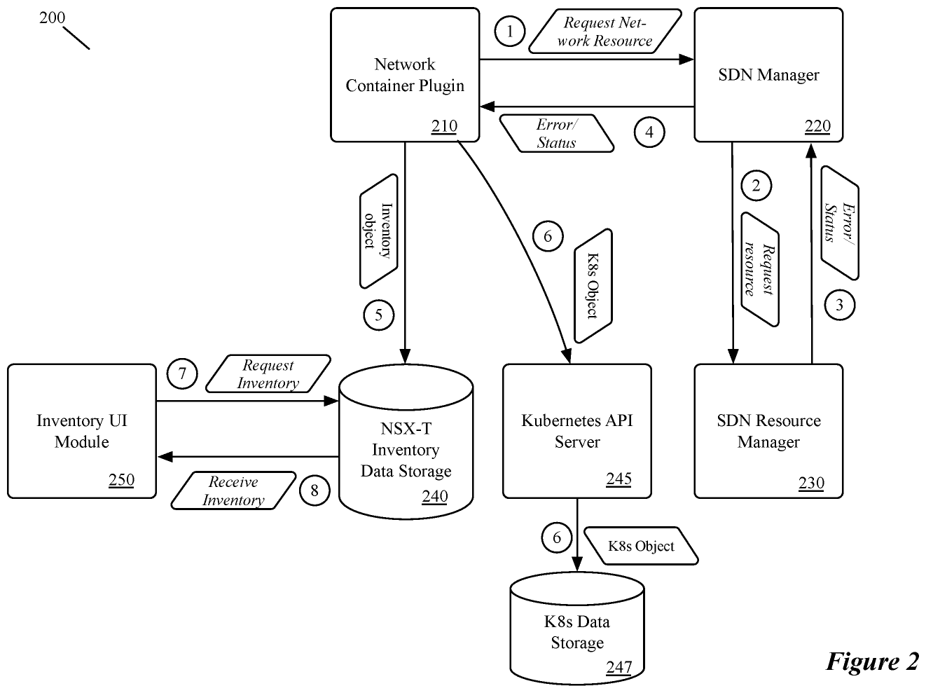

The present invention correlates Kubernetes resources with resources of an underlying network used to implement the Kubernetes resources. FIG. 2 illustrates a system 200 for correlating Kubernetes resources with resources of an underlying software defined network (SDN). The system 200 includes an NCP 210, an SDN manager 220, an SDN resource manager 230, a network inventory data storage 240, a Kubernetes API server 245, a Kubernetes data storage 247, and an inventory user interface (UI) module 250. The NCP 210 is an interface for the Kubernetes system with the SDN manager 220 that manages network elements of the underlying SDN that serve as forwarding elements (e.g., switches, routers, bridges, etc.) and service elements (e.g., firewalls, load balancers, etc.) to implement the Kubernetes resources.

The SDN resource manager 230 of FIG. 2 generically represents any of multiple modules or subsystems of the SDN that allocate and/or manage various resources (e.g., IP block allocators for allocating sets of IP addresses for IP pools, port managers for assigning/managing segment ports, IP allocators for supplying IP addresses for virtual servers, etc.). In some embodiments, SDN network resource managers are subsystems or modules of the SDN controller 115 (of FIG. 1) and/or of the compute managers and controllers 117. The network inventory data storage 240 (e.g., NSX-T inventory data storage), of FIG. 2, stores defining characteristics of various Kubernetes containers, including container inventory objects that track the correlations between Kubernetes resources and underlying resources of the SDN. In this embodiment, the inventory data is stored in network inventory data storage 240, separate from the configuration data storage 125 of FIG. 1. However, in other embodiments, the inventory data may be stored in other data storages such as configuration data storage 125. The network inventory data storage 240 of some embodiments also stores data defining NSX-T constructs. In some embodiments, SDN resource managers directly contact the network inventory data storage 240 to create and/or manage the NSX-T construct data. The Inventory UI module 250, of FIG. 2, retrieves inventory information from the network inventory data storage 240 and displays it in a UI (not shown).

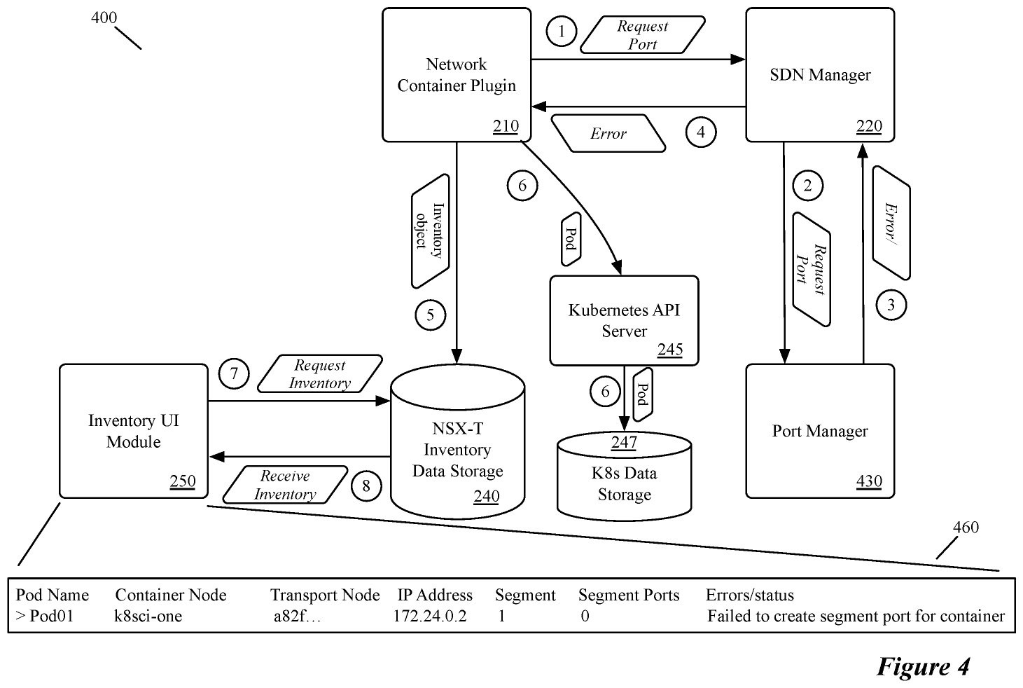

The system 200 correlates Kubernetes resources with the underlying SDN resources through a multi-stage process. (1) The NCP 210 requests that the SDN manager 220 provides network resources to instantiate a Kubernetes object or implement a function of a Kubernetes object. The request is tagged with a UUID that uniquely identifies the Kubernetes object. (2) the SDN manager 220 sends a command (in some embodiments tagged with the UUID of the Kubernetes object) to allocate the resources to the appropriate SDN resource manager 230 (examples of resource managers are described with respect to FIGS. 4, 6, and 7). (3) The SDN resource manager 230 sends either a status message if the resource is allocated, or an error message if the resource is not allocated or if there is some problem with an allocated resource, to the SDN manager 220. (4) The SDN manager 220 forwards the status or error message (or equivalent data in some other form), along with the UUID of the Kubernetes object (the attempted instantiation or implementation of which resulted in the status or error message) to the NCP 210. (5) The NCP 210 creates or updates a container inventory object, in the network inventory data storage 240, tagged with the UUID of the Kubernetes object. When the resource is successfully allocated/assigned without errors, the NCP 210 includes an identifier of the resource (and in some embodiments a status of that resource) in the container inventory object. When the resource is allocated/assigned, but with errors that did not prevent the allocation/assignment, the NCP 210 includes an identifier of the resource and sets or updates error fields for that resource in the container inventory object to include the status/error message from stage 3. When the resource is not allocated/assigned due to an error, the NCP 210 updates error fields and identifies a failed allocation. (6) The NCP 210 also creates or updates the Kubernetes object matching that UUID and adds the status or error message to the annotations field of that object. In the illustrated embodiments herein, the NCP 210 creates or updates the Kubernetes object in the Kubernetes data storage 247 by sending commands to create the object to the Kubernetes API server 245, which in turn creates/updates the Kubernetes object in the Kubernetes data storage 247. However, in other embodiments, the NCP 210 may communicate with the Kubernetes data storage 247 without using the Kubernetes API server 245 as an intermediary. (7) After the container inventory object has been created, the inventory UI module 250 requests the container inventory from the network inventory data storage 240. (8) The inventory UI module 250 then receives and displays the container inventory with the status and/or error messages included in each inventory object.

In the illustrated embodiments herein, the data defining the Kubernetes objects is stored in a different data storage 247 from the network inventory data storage 240. However, in other embodiments, the data defining the Kubernetes objects are stored in the network inventory data storage 240. The NCP 210, of some embodiments, creates the Kubernetes object regardless of whether the necessary SDN resources have been allocated to it by the SDN resource manager 230 and SDN manager 220. However, the Kubernetes object will not perform any of the intended functions of such an object that are dependent on any resources that failed to be allocated.

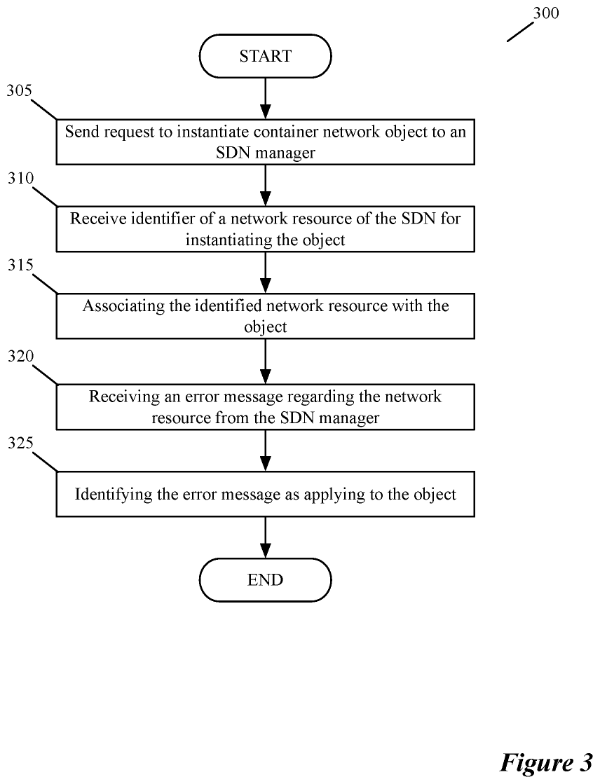

The NCP 210 plays a central role in the error tracking process. FIG. 3 conceptually illustrates a process 300 performed by an NCP for correlating Kubernetes resources with underlying resources of an SDN. The process 300, of FIG. 3, begins by sending (at 305) a request to instantiate a container network object to an SDN manager. The process 300 then receives (at 310) an identifier of a network resource of the SDN for instantiating the Kubernetes object. The identifier may identify a specific network resource that has been successfully allocated to instantiate the Kubernetes object, or may identify a type of network resource that has failed to be allocated to instantiate the Kubernetes object. The process 300 associates (at 315) the identified network resource with the Kubernetes object. The process 300 receives (at 320) an error message regarding the network resource from the SDN manager. The process 300 identifies (at 325) the error message as applying to the Kubernetes object. The process 300 then ends.

Although the process 300 shows these operations in a particular order, one of ordinary skill in the art will understand that some embodiments may perform the operations in a different order. For example, in some embodiments, the identifier of the network resource may be received at the same time as the error message regarding the network resource. Such a case may occur when an error message relates to the initial creation of a Kubernetes object, rather than an error in a previously assigned underlying resource of an existing Kubernetes object. Furthermore, in some embodiments, a single message may identify both a network resource or network resource type and an error message for the resource/resource type.

As mentioned with respect to FIG. 2, different types of SDN resources may be allocated to implement different Kubernetes resources. FIGS. 4, 6, and 7 illustrate some examples of correlating specific types of resources.

FIG. 4 illustrates a system 400 that correlates a Kubernetes pod object with a port (a segment port for the pod). FIG. 4 includes the NCP 210, SDN manager 220, network inventory data storage 240, Kubernetes API server 245, Kubernetes data storage 247 and inventory user interface (UI) module 250 introduced in FIG. 2. Additionally, FIG. 4 includes a port manager 430 of the SDN and display 460. The port manager 430 allocates ports of the SDN for the Kubernetes pod objects to use as segment ports.

The system 400 correlates Kubernetes pod objects with a port (or in the illustrated example, with an error message indicating a failure to allocate a port) through a multi-stage process. (1) The NCP 210 requests that the SDN manager 220 allocates a port for a Kubernetes pod object. The request is tagged with a UUID that uniquely identifies the Kubernetes pod object. (2) The SDN manager 220 sends a request (in some embodiments tagged with the UUID) for a port to the port manager 430. (3) The port manager 430 sends an error message, “Failed to create segment port for container,” to the SDN manager 220. (4) The SDN manager 220 forwards the error message (or equivalent data in some other form), along with the UUID of the Kubernetes pod object to the NCP 210. (5) The NCP 210 creates a container project inventory object in the network inventory data storage 240, tagged with the UUID of the Kubernetes object, and sets the error fields of that container project inventory object to include the error message “Failed to create segment port for container.” (6) The NCP 210 also creates/updates the Kubernetes pod object in the Kubernetes data storage 247 (e.g., through the Kubernetes API server 245) with the UUID and adds the error message to the annotations field of that pod object. The NCP 210, of some embodiments, creates the Kubernetes pod object regardless of whether the necessary port has been allocated to it by the port manager 430 and SDN manager 220. However, the Kubernetes pod object will not perform functions that are dependent on having a segment port allocated if the segment port allocation fails. (7) After the container project inventory object has been created, the inventory UI module 250 requests the container project inventory and each IP pool list from the network inventory data storage 240. (8) The inventory UI module 250 receives and displays, (e.g., as display 460) the container project inventory with the error message for the Kubernetes pod object.

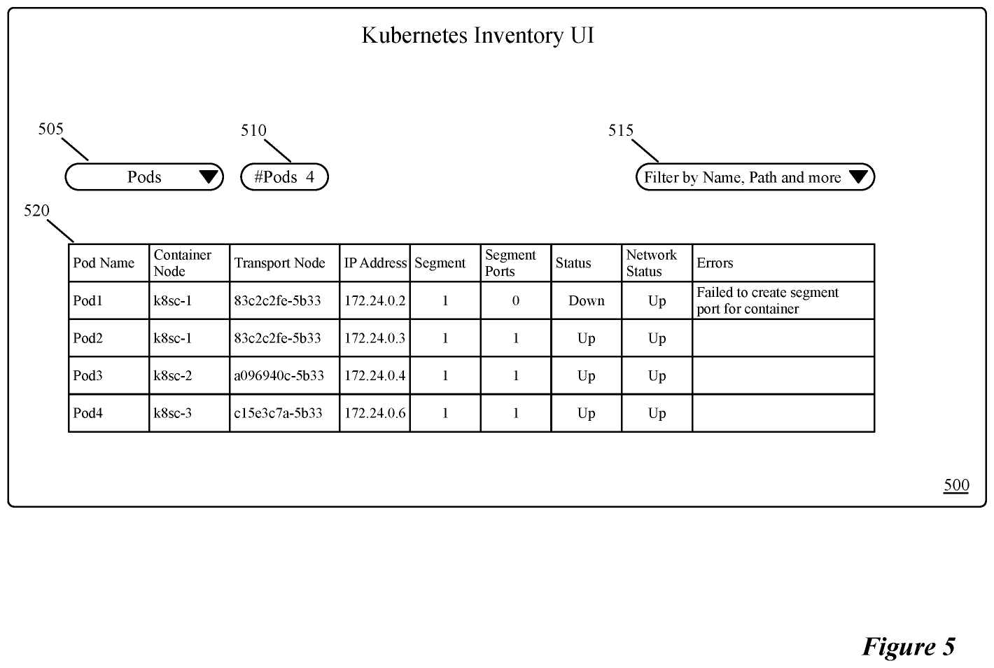

FIG. 5 illustrates a Kubernetes inventory UI 500 of some embodiments. The UI 500 includes an object type selector 505, an object counter 510, an object filter 515, and an object display area 520. The object type selector 505 allows a user to select which object type to display (e.g., pods, namespaces, services, etc.). The object counter 510 displays how many objects of the selected type are implemented in the Kubernetes container network. The object filter 515 allows a user to select sorting and/or filtering rules to be applied to the displayed list of Kubernetes objects. The object display area 520 lists each object of the selected object type along with details relating to each object. For the pod objects, the object display area 520 shows the pod name, the container node of each pod, the transport node of each pod, the IP address, the number of segments that the pod represents, the number of segment ports assigned to the pod, the status (up or down to represent working or non-working pods) of the pod, the status of the network on which the pod is operating, and any error messages relating to the pod. Here, as described with respect to FIG. 4, Pod1 is down because the port manager 430 of the underlying SDN was not able to allocate a port. Therefore, the status of Pod1 in FIG. 5 is shown as “down” and the error message “Failed to create segment port for container” is displayed in the row of Pod1. The rest of the pods are working normally, so their statuses are all shown as “up” and there are no error messages displayed for the other pods.

Although the UI of FIG. 5 is shown as including certain controls, display areas, and displaying particular types of information, one of ordinary skill in the art will understand that in other embodiments of the invention, the UIs may include additional or different features. For example, in some embodiments, rather than a control such as 505 for selecting an object type to be displayed, the UI may simultaneously show multiple display areas which each list a different Kubernetes object type. Similarly, the UIs of some embodiments may include more or fewer columns of data for the pods or other object types shown.

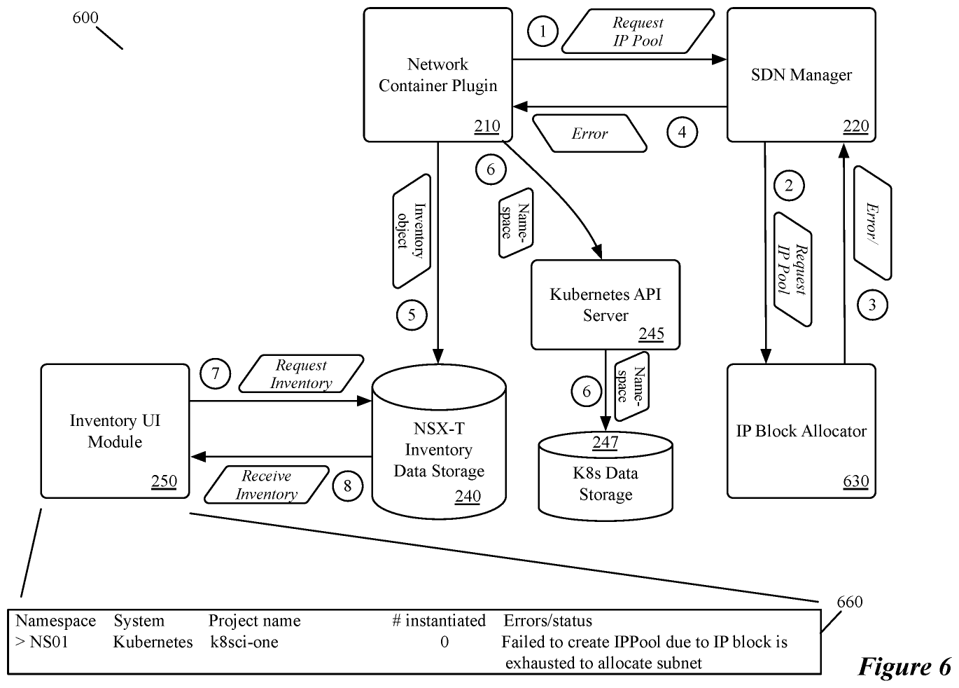

FIG. 6 illustrates a system 600 that correlates a Kubernetes Namespace object with an IP pool. FIG. 6 includes the NCP 210, SDN manager 220, network inventory data storage 240, Kubernetes API server 245, Kubernetes data storage 247, and inventory user interface (UI) module 250 introduced in FIG. 2. Additionally, FIG. 6 includes an IP block allocator 630 of the SDN and display 660. The IP block allocator 630 allocates sets of IP addresses to an IP pool for Kubernetes Namespace objects.

The system 600 correlates Kubernetes namespace objects with an IP pool (or in the illustrated example, with an error message of an IP pool allocation failure) through a multi-stage process. (1) The NCP 210 requests that the SDN manager 220 provide resources to instantiate an IP pool for a Kubernetes namespace object. The request is tagged with a UUID that uniquely identifies the Kubernetes namespace object. (2) The SDN manager 220 sends a request (in some embodiments tagged with the UUID) to allocate a set of IP addresses to the IP block allocator 630. (3) The IP block allocator 630 sends an error message, “Failed to create IPPool due to IP block is exhausted to allocate subnet,” to the SDN manager 220. (4) The SDN manager 220 forwards the error message (or equivalent data), along with the UUID of the Kubernetes namespace object to the NCP 210. (5) The NCP 210 creates a container project inventory object in the network inventory data storage 240, tagged with the UUID of the Kubernetes object, and sets the error fields of that container project inventory object to include the error message “Failed to create IPPool due to IP block is exhausted to allocate subnet.” (6) The NCP 210 also creates/updates, in the Kubernetes data storage 247 (e.g., via the Kubernetes API server 245) the Kubernetes namespace object with the UUID and adds the error message to the annotations field of that namespace object. The NCP 210, of some embodiments, creates the Kubernetes namespace object regardless of whether the necessary SDN resources have been allocated to it by SDN resource managers 230 and SDN manager 220. However, the Kubernetes namespace object will not perform functions that are dependent on having an IP pool allocated to it if the IP pool allocation fails. (7) After the container project inventory object has been created, the inventory UI module 250 requests the container project inventory and each IP pool list from the network inventory data storage 240. (8) The inventory UI module 250 receives and displays, (e.g., as display 660) the container project inventory with the error message for the Kubernetes namespace object.

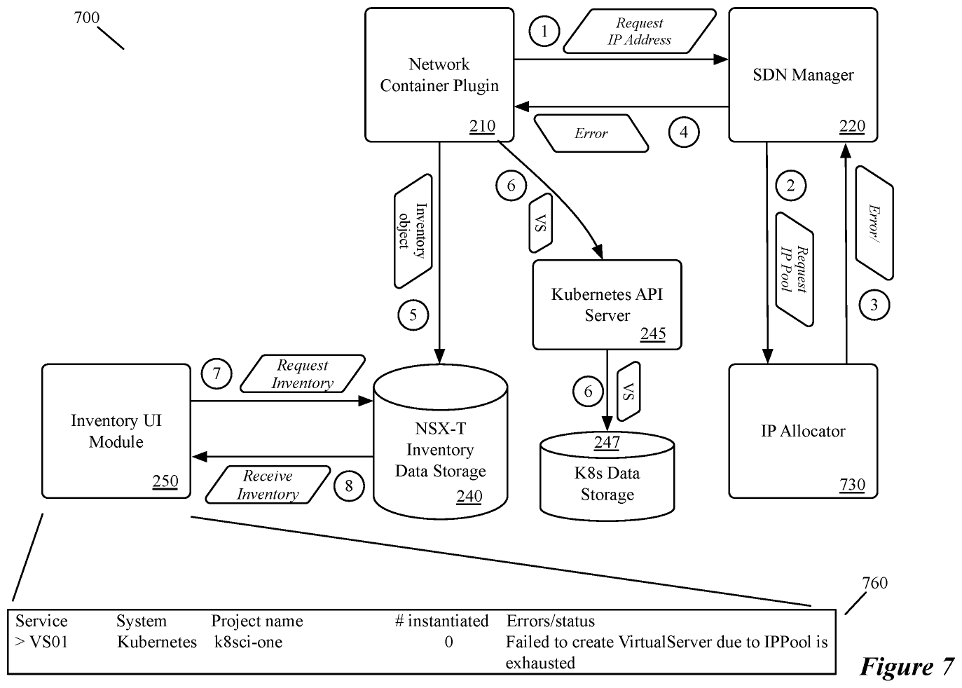

FIG. 7 illustrates a system 700 that correlates a Kubernetes virtual server object with an IP address. FIG. 7 includes the NCP 210, SDN manager 220, network inventory data storage 240, Kubernetes API server 245, Kubernetes data storage 247, and inventory user interface (UI) module 250 introduced in FIG. 2. Additionally, FIG. 7 includes an IP allocator 730 of the SDN and display 760. The IP allocator 730 allocates IP addresses (e.g., for Kubernetes virtual servers).

The system 700 correlates Kubernetes virtual servers with an IP address (or in the illustrated example, with an error message indicating a failure to allocate an IP address) through a multi-stage process. (1) The NCP 210 requests that the SDN manager 220 allocate an IP address for a Kubernetes virtual server. The request is tagged with a UUID that uniquely identifies the Kubernetes virtual server. (2) The SDN manager 220 sends a request (in some embodiments including the UUID) to allocate the IP address to IP allocator 730. (3) The IP allocator 730 sends an error message, “Failed to create VirtualServer due to IPPool is exhausted,” to the SDN manager 220. (4) The SDN manager 220 forwards the error message (or equivalent data), along with the UUID of the Kubernetes virtual server to the NCP 210. (5) The NCP 210 creates a container application inventory object, tagged with the UUID of the Kubernetes object, and sets the error fields of that container application inventory object to include the error message “Failed to create VirtualServer due to IPPool is exhausted.” (6) The NCP 210 also creates/updates the Kubernetes virtual server (VS) with the UUID in the Kubernetes data storage 247 (e.g., via the Kubernetes API server 245) and adds the error message to the annotations field of that virtual server. The NCP 210, of some embodiments, creates the Kubernetes virtual server regardless of whether the necessary SDN resources have been allocated to it by SDN resource managers 230 and SDN manager 220. However, the Kubernetes virtual server will not perform functions that are dependent on having an IP address allocated to it if the IP address allocation fails. (7) After the container application inventory object has been created, the inventory UI module 250 requests the container application inventory and each virtual server list from the network inventory data storage 240. (8) The inventory UI module 250 receives and displays, (e.g., as display 760) the container application inventory with the error message for the Kubernetes virtual server.

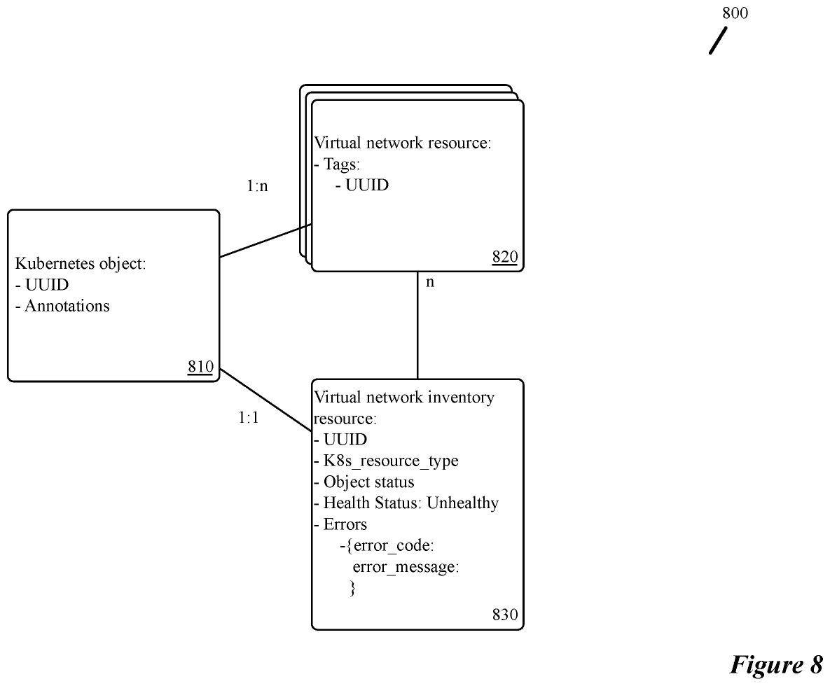

In some embodiments, each Kubernetes object is associated with its own inventory object that contains data regarding every SDN resource used to implement that Kubernetes object. FIG. 8 illustrates a data structure for tracking correlations of Kubernetes resources to resources of an underlying SDN used to implement the Kubernetes resources. FIG. 8 includes Kubernetes object data 810, virtual network resource data 820, and multiple instances of virtual network inventory resource data 830. Each type of data 810-830 is indexed by the UUID of the Kubernetes object. For each Kubernetes object 810, there is only one virtual network inventory resource 830. That is, a single virtual network inventory resource 830 tracks all resources, statuses, and errors for a single Kubernetes object. As described above in FIGS. 2, 4, 6, and 7, this virtual network inventory resource is created or updated when a new resource is allocated. The virtual network inventory resource 830, in FIG. 8, may be associated with multiple virtual network resources 820. Tracking all three types of data allows correlations in both directions. Starting from any given Kubernetes object data 810, all virtual network resources 820 can be identified as being associated with that Kubernetes object. In the other direction, any virtual network resource can be tracked from its virtual network resource data 820 to its associated Kubernetes object (via the Kubernetes object data 810). In some embodiments, the Kubernetes object data 810 is stored in a Kubernetes data storage (e.g., data storage 247 of FIG. 2). However, some embodiments store copies of the Kubernetes object data 810, of FIG. 8 or a subset of such data, on a network inventory data storage (e.g., a NSX-T inventory data storage 240 of FIG. 2).

In some embodiments, each Kubernetes object has a single corresponding inventory object which may track many SDN resources associated with the Kubernetes object. When a new SDN resource is assigned to implement or support a Kubernetes object, in some embodiments, that inventory object is created, if it has not previously been created, or updated, if the inventory object has previously been created. Although the examples described above are focused on errors at the time resources are allocated or assigned, in some embodiments, SDN resources that are successfully allocated or assigned to a Kubernetes object are identified in the corresponding inventory object as well. These identifiers allow errors in Kubernetes objects that result from errors in the SDN resources to be tracked to errors in the corresponding SDN resources even when those errors occur sometime after the resources are allocated/assigned. In some embodiments, the SDN resources identified in an inventory object include any SDN resource that is capable of being a source of error for the corresponding Kubernetes object.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

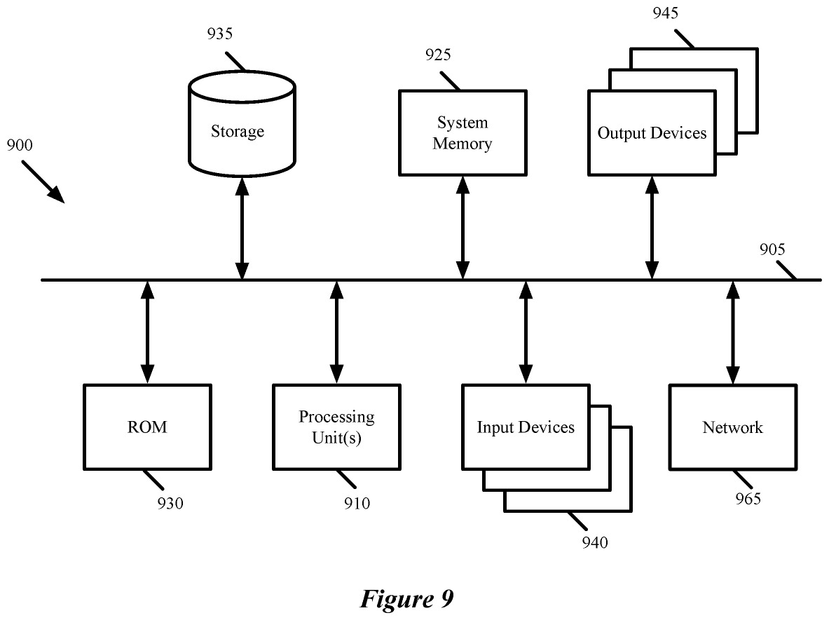

FIG. 9 conceptually illustrates a computer system 900 with which some embodiments of the invention are implemented. The computer system 900 can be used to implement any of the above-described hosts, controllers, gateway and edge forwarding elements. As such, it can be used to execute any of the above-described processes. This computer system 900 includes various types of non-transitory machine-readable media and interfaces for various other types of machine-readable media. Computer system 900 includes a bus 905, processing unit(s) 910, a system memory 925, a read-only memory 930, a permanent storage device 935, input devices 940, and output devices 945.

The bus 905 collectively represents all system, peripheral, and chipset buses that communicatively connect the numerous internal devices of the computer system 900. For instance, the bus 905 communicatively connects the processing unit(s) 910 with the read-only memory 930, the system memory 925, and the permanent storage device 935.

From these various memory units, the processing unit(s) 910 retrieve instructions to execute and data to process in order to execute the processes of the invention. The processing unit(s) may be a single processor or a multi-core processor in different embodiments. The read-only-memory (ROM) 930 stores static data and instructions that are needed by the processing unit(s) 910 and other modules of the computer system. The permanent storage device 935, on the other hand, is a read-and-write memory device. This device is a non-volatile memory unit that stores instructions and data even when the computer system 900 is off. Some embodiments of the invention use a mass-storage device (such as a magnetic or optical disk and its corresponding disk drive) as the permanent storage device 935.

Other embodiments use a removable storage device (such as a floppy disk, flash drive, etc.) as the permanent storage device 935. Like the permanent storage device 935, the system memory 925 is a read-and-write memory device. However, unlike storage device 935, the system memory 925 is a volatile read-and-write memory, such as random access memory. The system memory 925 stores some of the instructions and data that the processor needs at runtime. In some embodiments, the invention's processes are stored in the system memory 925, the permanent storage device 935, and/or the read-only memory 930. From these various memory units, the processing unit(s) 910 retrieve instructions to execute and data to process in order to execute the processes of some embodiments.

The bus 905 also connects to the input and output devices 940 and 945. The input devices 940 enable the user to communicate information and select commands to the computer system 900. The input devices 940 include alphanumeric keyboards and pointing devices (also called “cursor control devices”). The output devices 945 display images generated by the computer system 900. The output devices 945 include printers and display devices, such as cathode ray tubes (CRT) or liquid crystal displays (LCD). Some embodiments include devices such as touchscreens that function as both input and output devices 940 and 945.

Finally, as shown in FIG. 9, bus 905 also couples computer system 900 to a network 965 through a network adapter (not shown). In this manner, the computer 900 can be a part of a network of computers (such as a local area network (“LAN”), a wide area network (“WAN”), or an Intranet), or a network of networks (such as the Internet). Any or all components of computer system 900 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessors or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. For instance, several of the above-described embodiments deploy gateways in public cloud datacenters. However, in other embodiments, the gateways are deployed in a third-party's private cloud datacenters (e.g., datacenters that the third-party uses to deploy cloud gateways for different entities in order to deploy virtual networks for these entities). Thus, one of ordinary skill in the art would understand that the invention is not to be limited by the foregoing illustrative details, but rather is to be defined by the appended claims.

1. A method of tracking errors in a container cluster network overlaying a software defined network (SDN), the method comprising:
sending a request to instantiate a container cluster network object to an SDN manager of the SDN;
receiving an identifier of a network resource of the SDN for instantiating the container cluster network object;
associating the identified network resource with the container cluster network object;
receiving an error message regarding the network resource from the SDN manager; and
identifying the error message as applying to the container cluster network object.

2. The method of claim 1, wherein the error message indicates a failure to initialize the network resource.

3. The method of claim 1, wherein the container cluster network object is one of a namespace, a pod of containers, and a service.

4. The method of claim 1, wherein associating the identified network resource with the container cluster network object comprises creating a tag for the identified network resource that identifies the container cluster network object.

5. The method of claim 4, wherein the tag comprises a universally unique identifier (UUID).

6. The method of claim 1, wherein associating the identified network resource with the container cluster network object comprises:
creating an inventory of network resources used to instantiate the container cluster network object; and
adding the identifier of the network resource to the inventory.

7. The method of claim 6, wherein the network resource is a first network resource for instantiating the container cluster network object, the method further comprising:
receiving an identifier of a second network resource of the SDN for instantiating the container cluster network object; and
adding the identifier of the second network resource to the inventory.

8. The method of claim 6 further comprising:
in a graphical user interface (GUI), displaying an identifier of the inventory of the network resources in association with an identifier of the container cluster network object.

9. The method of claim 8 further comprising, displaying the error message in association with the inventory of network resources.

10. The method of claim 8, wherein displaying the inventory further comprises displaying a status of the instantiation of the container cluster network object.

11. A non-transitory machine readable medium storing a program that when executed by at least one processing unit tracks errors in a container cluster network overlaying a software defined network (SDN), the program comprising sets of instructions for:
sending a request to instantiate a container cluster network object to an SDN manager of the SDN;
receiving an identifier of a network resource of the SDN for instantiating the container cluster network object;
associating the identified network resource with the container cluster network object;
receiving an error message regarding the network resource from the SDN manager; and
identifying the error message as applying to the container cluster network object.

12. The non-transitory machine readable medium of claim 11, wherein the error message indicates a failure to initialize the network resource.

13. The non-transitory machine readable medium of claim 11, wherein the container cluster network object is one of a namespace, a pod of containers, and a service.

14. The non-transitory machine readable medium of claim 11, wherein associating the identified network resource with the container cluster network object comprises creating a tag for the identified network resource that identifies the container cluster network object.

15. The non-transitory machine readable medium of claim 14, wherein the tag comprises a universally unique identifier (UUID).

16. The non-transitory machine readable medium of claim 11, wherein associating the identified network resource with the container cluster network object comprises:
creating an inventory of network resources used to instantiate the container cluster network object; and
adding the identifier of the network resource to the inventory.

17. The non-transitory machine readable medium of claim 16, wherein the network resource is a first network resource for instantiating the container cluster network object, the program further comprising sets of instructions for:
receiving an identifier of a second network resource of the SDN for instantiating the container cluster network object; and
adding the identifier of the second network resource to the inventory.

18. The non-transitory machine readable medium of claim 16 further comprising:
in a graphical user interface (GUI), displaying an identifier of the inventory of the network resources in association with an identifier of the container cluster network object.

19. The non-transitory machine readable medium of claim 18 further comprising displaying the error message in association with the inventory of network resources.

20. The non-transitory machine readable medium of claim 18, wherein displaying the inventory further comprises displaying a status of the instantiation of the container cluster network object.
